(19) United States
(12) Patent Application Publication
(10) Pub. No.: US 2018/0027296 A1
(43) Pub. Date: Jan. 25, 2018

(54) IMAGE PROCESSING DEVICE, AND METHOD AND SYSTEM FOR CONTROLLING IMAGE PROCESSING DEVICE

(71) Applicant: SAMSUNG ELECTRONICS CO., LTD., Suwon-si, Gyeonggi-do (KR)

(72) Inventors: Jong Ho LEA, Seongnam-si Gyeonggi-do (KR); Yong Suk CHOI, Seoul (KR); Woo Seok KIM, Bucheon-si Gyeonggi-do (KR)

(21) Appl. No.: 15/549,536

(22) PCT Filed: Feb. 4, 2016
(86) PCT No.: PCT/KR2016/001251

§ 371 Date: Aug. 8, 2017

(30) Foreign Application Priority Data
Feb. 11, 2015 (KR) 10-2015-0020866

(51) Int. Cl. H04N 21/475; H04N 21/482; H04N 21/45

(52) U.S. Cl. CPC H04N 21/4756; H04N 21/4516; H04N 21/4826; H04N 21/482; H04N 21/475

(57) ABSTRACT

An image processing apparatus including: a display configured to display an image of content; a storage configured to store information about the content; a communicator configured to communicate with an external apparatus that provides information about recommendation to the content; and at least one processor configured to determine rating information predicted with regard to the content, store the rating information in the storage, receive rating information updated with regard to the content from the external apparatus in response to a user's request, and provide recommendation information about the content based on the predicted rating information stored in the storage and the updated rating information received from the external apparatus.

### TECHNICAL FIELD

Apparatuses and methods consistent with the exemplary embodiments relate to an image processing apparatus that processes an video signal in accordance with an image processing process in order to display an image based on the video signal by itself or output the video signal to an external apparatus, a controlling method of the same and a system, and more particularly to an image processing apparatus having an improved structure of item recommendation service provided based on user ratings under large-scale user and item environments, and a method and system for controlling the same.

### BACKGROUND ART

An image processing apparatus processes a video signal/video data received from the exterior in accordance with various video processing processes. The image processing apparatus may display an image based on the processed video data on its own display panel, or output the processed video signal to another display apparatus provided with a panel so that on the corresponding display apparatus can display an image based on the processed video signal. That is, the image processing apparatus may include the panel capable of displaying an image or include no panel as long as it can process the video data. For example, the former may include a television (TV), and the latter may include a set-top box.

To meet a user's various demands, the image processing apparatus accesses a server via a network, gets a supported function corresponding to a user's demand from the server, and processes the function. Since the image processing apparatus is manufactured on a mass production basis, its own system resources are restricted. Therefore, the image processing apparatus receives a service from a server having relatively abundant system resources and more specialized in processing data, thereby providing more diversified and developed functions to a user.

For example, a server communicates with many image processing apparatuses to build a large-scale “m to n” environment, and proves a collaborative recommendation service to the image processing apparatus based on the built environment. The “m to n” environment may be given in the form of a user to an item, or an item to an item. For example, the “m to n” environment may be given as a matrix form dataset that includes user ratings scored with regard to each channel or content. Based on this dataset, the server may recommend a channel or content highly preferred by a certain user to an image processing apparatus of the user.

By the way, if the number of image processing apparatuses having access to the server is great and their respective users simultaneously access the server and give ratings with regard to a channel, the server is burdened with a lot of matrix computations in response to updating, addition and deletion of the user ratings. In this case, the server is hard to quickly update the dataset in response to the ratings input by users, and has inefficient scalability. This means that it is practically difficult to provide the collaborative recommendation service to a user in real time. Accordingly, to effectively provide the collaborative recommendation service, there is a need of decreasing the burden and communication traffic of the server in terms of data computations.

### DISCLOSURE

### Technical Solution

An image processing apparatus includes: a display configured to display an image of content; a storage configured to store information about the content; a communicator configured to communicate with an external apparatus that provides information about recommendation to the content; and at least one processor configured to determine rating information predicted with regard to the content, store the rating information in the storage, receive rating information updated with regard to the content from the external apparatus in response to a user's request, and provide recommendation information about the content based on the predicted rating information stored in the storage and the updated rating information received from the external apparatus. Thus, it is possible to quickly provide a recommendation service for content in response to a user's request.

The at least one processor may process a rating table, in which ratings of the user for one or more pieces of valid content including the content are tabulated based on the predicted rating information, the updated rating information and ratings directly given by the user are tabulated, to be stored in the storage. The recommendation information may include a list of one or more pieces of valid content, and the at least one processor may select the valid content, which belongs to a preset ranking, for the list based on the ratings of the rating table stored in the storage. Thus, it is possible to provide a recommendation service reflecting a user's preference for various pieces of content as much as possible.

The predicted rating information may include a rating previously predicted by the external apparatus based on preference of a plurality of other users for the content, and the at least one processor may process the predicted rating information, which is received from the external apparatus corresponding to the user, to be stored in the storage. The predicted rating information may be predicted with regard to the content, to which the user does not directly give any rating, among the plurality of pieces of valid content. Thus, it is possible to predict a user's preference with regard to an item to which the user gives no ratings.

The updated rating information may include difference values from the predicted rating information, which are derived corresponding to ratings input with regard to one or more pieces of valid content having similarity with the content by a preset level or higher. If the user makes an input of giving a rating to the content while the predicted rating information is stored in the storage, the at least one processor may process the predicted rating information stored in the storage to be updated based on the input. Thus, the predicted rating information stored in the image processing apparatus is easily updated with less data and few computations.

The at least one processor may process a user interface (UI) image to be displayed for allowing the user to give a rating to the content of the image being displayed on the display, and process the predicted rating information stored in the storage to be updated based on the rating given through the UI image. Thus, a user can easily give a rating to content.

A method of controlling an image processing apparatus includes: communicating with an external apparatus that provides information about recommendation to content; determining rating information predicted with regard to the content to be stored in a storage of the image processing apparatus; receiving rating information updated with regard to the content from the external apparatus; and providing recommendation information about the content based on the predicted rating information stored in the storage and the updated rating information received from the external apparatus in response to a user's request. Thus, it is possible to quickly provide a recommendation service for content in response to a user's request.

The providing the recommendation information about the content may include: storing the storage with a rating table, in which ratings of the user for one or more pieces of valid content including the content are tabulated based on the predicted rating information, the updated rating information and ratings directly given by the user are tabulated. The recommendation information may include a list of one or more pieces of valid content, and the providing the recommendation information about the content may include: selecting the valid content, which belongs to a preset ranking, for the list based on the ratings of the rating table stored in the storage. Thus, it is possible to provide a recommendation service reflecting a user's preference for various pieces of content as much as possible.

The predicted rating information may include a rating previously predicted by the external apparatus based on preference of a plurality of other users for the content, and the determining the predicted rating information to be stored in the storage of the image processing apparatus may include: storing the storage with the predicted rating information, which is received from the external apparatus corresponding to the user. The predicted rating information may be predicted with regard to the content, to which the user does not directly give any rating, among the plurality of pieces of valid content. Thus, it is possible to predict a user's preference with regard to an item to which the user gives no ratings.

The updated rating information may include difference values from the predicted rating information, which are derived corresponding to ratings input with regard to one or more pieces of valid content having similarity with the content by a preset level or higher. The method may further including updating the predicted rating information stored in the storage based on an input if the user makes the input of giving a rating to the content while the predicted rating information is stored in the storage. Thus, the predicted rating information stored in the image processing apparatus is easily updated with less data and few computations.

The updating the predicted rating information stored in the storage based on the input may include displaying an user interface (UI) for allowing the user to give a rating to the content of the image being displayed, and processing the predicted rating information stored in the storage to be updated based on the rating given through the image. Thus, it is easy for a user to give a rating to content.

A system includes: a server; and a plurality of image processing apparatuses communicating with the server, the server including a server storage configured to store rating information given to a plurality of pieces of content by a plurality of users respectively corresponding to the plurality of image processing apparatuses; and at least one server processor configured to determine the user's rating information predicted with regard to the plurality of pieces of content based on the rating information stored in the server storage and derive updated rating information including difference values from the predicted rating information as the plurality of users inputs the rating information, and the image processing apparatus including a storage configured to store the predicted rating information corresponding to a user of the image processing apparatus determined by the server processor; and at least one processor configured to receive the updated rating information from the server in response to the user's request and provide recommendation information about the content based on the predicted rating information stored in the storage and the updated rating information received from the server. Thus, it is possible to quickly provide the recommendation service for the content in response to a request of the user corresponding to each image processing apparatus.

### DESCRIPTION OF DRAWINGS

FIG. 1 shows an example of a system according to an exemplary embodiment;

FIG. 2 shows an example of a dataset of ratings on content according to users, which is built by a server in the system of FIG. 1;

FIG. 3 is a block diagram of an image processing apparatus and the server in the system of FIG. 1;

FIG. 4 shows an example of a recommendation content list displayed on the image processing apparatus in the system of FIG. 1;

FIG. 5 shows an example that a user gives a rating to content being currently displayed on the image processing apparatus in the system of FIG. 1;

FIG. 6 shows an example that a certain user updates a rating of a certain item in a dataset of a user-item matrix, according to an exemplary embodiment;

FIG. 7 shows an example of discriminating between items affected and unaffected by similarity according to a user's activities in the dataset of FIG. 6;

FIG. 8 shows an example of a set of equations for incremental similarity computation according to an exemplary embodiment;

FIG. 9 shows an example of equations of respective factors when a new rating is given to an item having no rating in the set of equations of FIG. 8;

FIG. 10 shows an example of equations of respective factors when a rating is deleted from an item having the ratings in the set of equations of FIG. 8;

FIG. 11 shows an example of equations of respective factors when the existing rating is updated with a difference value in the set of equations of FIG. 8;

FIG. 12 is a block diagram of the server for providing a recommendation service based on a user-item environment according to an exemplary embodiment;

FIG. 13 is a block diagram of the image processing apparatus for providing a recommendation service based on a user-item environment according to an exemplary embodiment;

FIG. 14 shows an example of an equation that represents a correlation between factors to be cached in a user rating caching table (URCT) of the image processing apparatus according to an exemplary embodiment;

FIG. 15 and FIG. 16 are examples of recalculating the rating by incremental computation with reference to the URCT and caching the recalculated and updated ratings in the URCT according to an exemplary embodiment;

FIG. 17 shows an example of the recommendation content list displayed in the image processing apparatus according to an exemplary embodiment;

FIG. 18 shows an example of the recommendation content list displayed after updating the ratings from the recommendation content list of FIG. 17;

FIG. 19 is a flowchart of controlling the server according to an exemplary embodiment;

FIG. 20 is a flowchart of controlling the image processing apparatus according to an exemplary embodiment;

FIG. 21 is a graph showing comparison in average time taken in calculating similarity per item pair between a method according to an exemplary embodiment and a conventional method;

FIG. 22 is a graph showing comparison in average time taken in calculating user-item similarity according to the number of co-raters between the method according to an exemplary embodiment and the conventional method;

FIG. 23 is a graph showing comparison in average time taken in calculating item similarity according to the number of rated items between the method according to an exemplary embodiment and the conventional method;

FIG. 24 is a graph showing comparison in average calculation time per item pair according to an accumulation percentage of a user-item rating dataset between the method according to an exemplary embodiment and the conventional method; and

FIG. 25 is a graph showing comparison in average time taken in recommendation per user with or without the URCT between the method according to an exemplary embodiment and the conventional method.

### BEST MODE

Below, exemplary embodiments will be described in detail with reference to accompanying drawings. The following descriptions of the exemplary embodiments are made by referring to elements shown in the accompanying drawings, in which like numerals refer to like elements having substantively the same functions.

In the description of the exemplary embodiments, an ordinal number used in terms such as a first element, a second element, etc. is employed for describing variety of elements, and the terms are used for distinguishing between one element and another element. Therefore, the meanings of the elements are not limited by the terms, and the terms are also used just for explaining the corresponding embodiment without limiting the idea of the invention.

Further, the exemplary embodiments will describe only elements directly related to the idea of the invention, and description of the other elements will be omitted. However, it will be appreciated that the elements, the descriptions of which are omitted, are not unnecessary to realize the apparatus or system according to the exemplary embodiments. In the following descriptions, terms such as “include” or “have” refer to presence of features, numbers, steps, operations, elements or combination thereof, and do not exclude presence or addition of one or more other features, numbers, steps, operations, elements or combination thereof.

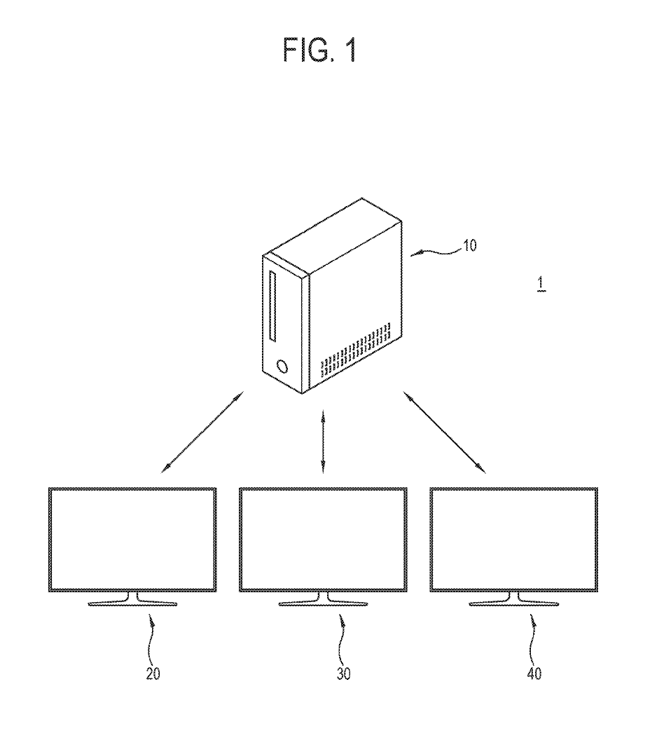

FIG. 1 shows an example of a system 1 according to an exemplary embodiment.

As shown in FIG. 1, the system 1 according to the present exemplary embodiment includes a server 10, and a plurality of image processing apparatuses 20, 30 and 40 having access to and communicating with the server 10. In this exemplary embodiment, the plurality of image processing apparatuses 20, 30 and 40 are achieved by televisions (TV), but not limited thereto. Alternatively, a tablet computer, a set-top box and the like apparatuses may be employed as the image processing apparatuses. Each of the image processing apparatuses 20, 30 and 40 may have access to the server by a wire or wirelessly, and there are no limits to the kind of communication protocols for communication access.

The plurality of image processing apparatuses 20, 30 and 40 receives content from an image source (not shown), and processes the received content to display a content image. For example, the image processing apparatuses 20, 30 and 40 may process a broadcasting signal from a broadcasting station and display a channel image, or receive and display a content image from an external apparatus of providing content. Such an image source (not shown) may be the same as or different from the server 10.

The server 10 collects metadata related to content from the plurality of image processing apparatuses 20, 30 and 40, and builds a metadata environment based on the metadata in collaboration with users. Further, the server provides a specialized service based on the built environment to each individual image processing apparatus 20, 30 or 40. Such a service may be variously provided in accordance with the kind and use of the built metadata environments.

First, as an example of the metadata environment built in collaboration with users, there is a rating database of users with regard to content. Each user of the image processing apparatuses 20, 30 and 40 gives a rating to content of an image displayed on his/her own image processing apparatus 20, 30 or 40, and sends the content and rating information about the content to the server 10. Based on the information collected from the image processing apparatuses 20, 30 and 40, the server 10 builds a database or dataset of the ratings on the content according to users.

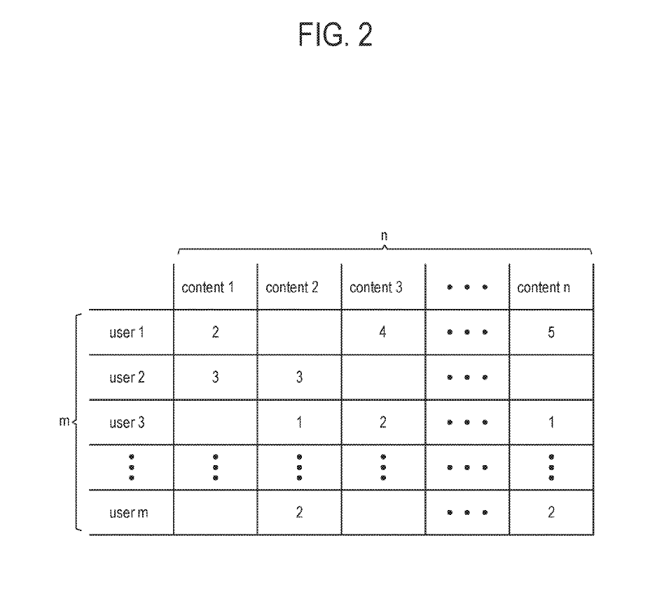

FIG. 2 shows an example of a dataset of ratings on content according to users, which is built by the server 10.

As shown in FIG. 2, there are m users from “user 1” to “user m,” and there are n pieces of content from “content 1” to “content n”. A correlation between a user and content is represented in the form of a matrix of “m by n.” Referring to FIG. 2, the “user 1” gave ratings of 2 points to the “content 1,” 4 points to the “content 3,” and 5 points to “content n.” On the other hand, the “user 2” gave ratings of 3 points to the “content 1,” and 3 points to the “content 2”.

The server 10 collects rating information about the content from users, and builds a dataset in an m by n matrix, i.e. a user-item matrix. Here, “m” becomes higher if the number of image processing apparatuses 20, 30 and 40 having access to the server 10 increases, and “n becomes higher if the number of pieces of content provided to the image processing apparatuses 20, 30 and 40 increases. In this case, the metadata environment built in the server 10, i.e. The size of dataset becomes larger.

The dataset having a matrix form may be varied depending on what items are contrasted in “m by n,” i.e. what items are respectively given as “m” and “n.” Like this exemplary embodiment, a user may be contrasted with an item such as content, a channel, etc. Alternatively, an item may be contrasted with another item different in kind. Further, the item is not limited to content or a channel. For example, a buying site like an Internet shopping mall may have an environment where users are contrasted with shopping goods.

Based on the metadata environment of a user versus content, the server 10 may provide various services to each of the image processing apparatuses 20, 30 and 40. As a representative example of the services, there is a recommendation service.

The server 10 builds a recommendation system personalized like this exemplary embodiment, and determines a user's tastes or preferences, thereby providing customized content. There is a method of analyzing similarity with another user in order to determine a certain user's preferences for pieces of content, and then recommending content, and this method is called a collaborative recommendation (CR). With this, the server 10 may determine preferences of users based on the collaborative recommendation.

As an example of the collaborative recommendation, there are a user or item-based collaborative recommendation, a trust network-based collaborative recommendation, a content-based collaborative recommendation, etc. By the way, these methods have a problem of sparsity in common and are thus difficult to effectively recommend the content in an early stage of a recommendation service.

As shown in FIG. 2, the problem of sparsity is caused by presence of null data in the dataset where the content is rated by users. For example, the “user 1” did not give any rating to the “content 2,” and the “user 2” did not give any rating to the “content 3”. Like this, no rating is the null data. Since the content having the null data has no ratings for determining a user's preferences, it is difficult to determine the user's preferences. In other words, accuracy in calculating similarity between items is very low in an early stage of the service where there is a lack of information about metadata input by a user or in a stage where metadata input is relatively less as compared with many items due to too many items. In result, recommendation performance is deteriorated. Therefore, if a problem of sparsity is solved in the collaborative recommendation under the metadata environment of user-to-item or item-to-item, the recommendation performance will be improved.

Below, some collaborative recommendations will be described in brief.

A user-based collaborative recommendation refers to a personalized recommendation technique that recommends an item expected to be highly preferred by a certain user based on rating information of another user who shows a rating propensity similar to the certain user. The user-based collaborative recommendation is performed by obtaining similarity between user rating vectors after ratings given by a user to an item are stored in a user-item matrix, and predicting a rating for an item that has not been rated yet. Since the user-based collaborative recommendation is independent of content of an item, it is possible to recommend various items, but it is difficult to make a recommendation to a cold start user whose rating information is insufficient.

As a method of overcoming the problem of the cold start user, a trust network-based collaborative recommendation refers to a technique that employs correlation information on a trust network in recommending an item. This is based on the assumption that a certain user and another user having a correlation on the trust network show a similar propensity with regard to an item. The trust network-based collaborative recommendation may make up for the problem of the cold start user to some extent, but may be also deteriorated in performance in an early service stage where the number of users is absolutely insufficient.

As a technique of employing item metadata in a recommendation, a content-based collaborative recommendation builds a naive Bayesian classifier (NBC) unique to each of users based on the item metadata of the items to which users give ratings. The NBC is one of classifying techniques that use rules of Bayes. Using the NBC to predict ratings with regard to all the items to which users do not give the ratings, a matrix of storing user-item ratings is converted into a full-matrix. By applying the user-based collaborative recommendation based on the predicted rating information, it is possible to make up for the problem of the sparsity in the user-based collaborative recommendation. However, this technique is also deteriorated in recommendation performance under an environment where the user-item rating information is remarkably insufficient.

By the way, if many users simultaneously update the ratings of the items in a large-scale user-item matrix including a lot of users and a lot of items, it is difficult to quickly update the user-item matrix because of a lot of matrix computations. This increases time taken in a real-time collaborative recommendation, and it is thus difficult to efficiently provide the recommendation service. Further, the burden and communication traffic of the server 10 increase due to these matrix computations.

Accordingly, the present exemplary embodiment proposes a method of efficiently providing the real-time collaborative recommendation service to a user, and this will be described later.

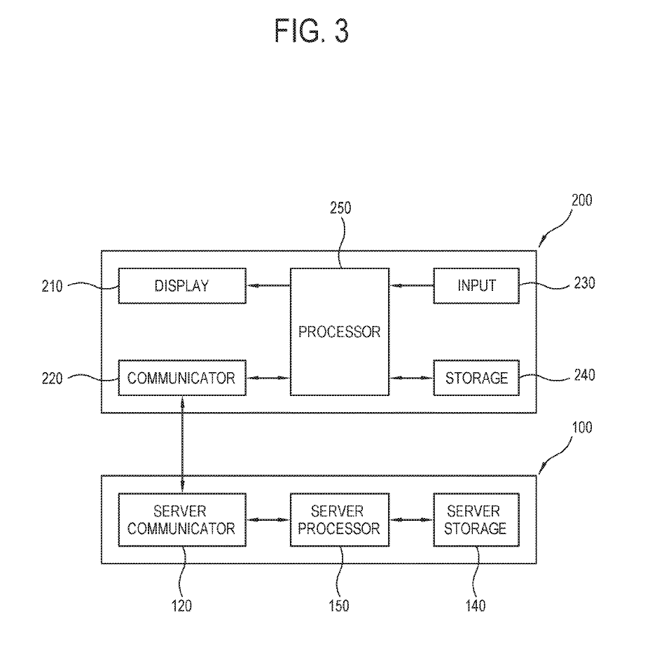

FIG. 3 is a block diagram of an image processing apparatus 200 and a server 100 in the system of FIG. 1;

As shown in FIG. 3, the image processing apparatus 200 includes a display 210 for displaying an image, a communicator 220 for performing communication to transmit and receive data to and from the outside, an input 230 for receiving a user's input, a storage 240 for storing data, and a processor 250 for controlling general operations of the image processing apparatus 200 and processing data with various processes. This image processing apparatus 200 is equivalent to each of the foregoing image processing apparatuses 20, 30 and 40 described with reference to FIG. 1, and may be achieved by various apparatuses as well as a TV.

Further, the server 100 includes a server communicator 120 for communicating with the image processing apparatus 200, a server storage 140 for storing data, and a server processor 150 for controlling general operations of the server 100 and processing data transmitted and received through the server communicator 120. The server 100 is equivalent to the foregoing server 10 described with reference to FIG. 1, and may be achieved by a general server computer or various apparatus to be used as the server.

Below, the elements of the image processing apparatus 200 will be described.

The display 210 displays an image based on a video signal processed by the processor 250. The display 210 may be materialized by various display types such as liquid crystal, plasma, light-emitting diodes, organic light-emitting diodes, surface-conduction electron-emitters, carbon nano-tubes, nano-crystal, etc. without limitations.

The display 210 may include additional elements in accordance with its types. For example, if the display 210 is achieved by the liquid crystal, the display 210 includes a liquid crystal display (LCD) panel (not shown), a backlight unit (not shown) for supplying light to the LCD panel, and a panel driving substrate (not shown) for driving the LCD panel (not shown).

The communicator 220 transmits and receives data locally or through a network so that the image processing apparatus 200 can interactively communicate with the outside. For example, the communicator 220 has access to the external apparatus (not shown) or the server 100 through a wired/wireless wide area network in accordance with preset communication protocols. The communicator 220 may be achieved by an assembly of connection ports or modules that comply with respective communication standards, and there are no limits to the kind or type of connection protocols or apparatus to be connected. The communicator 220 may be internally provided in the image processing apparatus 200, or the whole or part thereof may be additionally installed in the form of add-on or dongle to the image processing apparatus 200.

The communicator 220 may transmit and receive a signal based on individual communication protocols with regard to the connected apparatus. For example, the communicator 220 may transmit and receive a video signal may be transmitted and received based on various standards such as radio frequency (RF) signal, composite/component video, super video, SCART, high definition multimedia interface (HDMI), DisplayPort, a unified display interface (UDI), wireless HD, etc.

To receive both an analog signal and a digital signal, the communicator 220 includes modules for them. For example, the communicator 220 may include a tuner (not shown) to be tuned to a video stream of a broadcasting signal received in an antenna by a RF method, an Ethernet module (not shown) for receiving a digital packet data through the Internet or the like network, etc.

The input 230 sends the processor 250 a variety of preset control commands or information in response to a user's operation or inputs. The input 230 informationizes various events generated by a user's control corresponding to his/her intention and sends the information to the processor 250. The input 230 may be achieved in various forms for generating input information from a user. For example, the input 230 may include a key/a button installed outside the image processing apparatus 200, a remote controller provided separately from the main body of the image processing apparatus 200 and communicating with the communicator 220, or a touch screen installed in the display 210.

The storage 240 stores a variety of data under process and control of the processor 250. The storage 240 is achieved by a flash-memory, a hard-disc drive or the like nonvolatile memory to preserve data regardless of supply of system power. The storage 240 is accessed by the processor 250 and performs reading, writing, editing, deleting, updating and the like with regard to data.

The processor 250 performs various processes with regard to a signal/data received in the communicator 220. If an video signal is received in the communicator 220, the processor 250 applies the image processing process to the video signal and outputs the processed video signal to the display 210 so that the display 210 can display an image based on the video signal.

There is no limit to the kind of image processing process performed by the processor 250, and the video processing process may for example include demultiplexing for separating an input signal into sub-signals such as video, audio and additional data, decoding corresponding to video formats of the video signal, de-interlacing for converting an image stream from an interlaced type into a progressive type, scaling for adjusting the video signal to have a preset resolution, noise reduction for improving image quality, detail enhancement, frame refresh rate conversion, etc.

The processor 250 may perform various processes in accordance with the kind and characteristic of data, and thus the processes performed in the processor 250 are not limited to the image processing processes. Further, the data processible by the processor 250 is not limited to the only the data received in the communicator 220. For example, if a user inputs a speech to the image processing apparatus 200, the processor 250 may process the speech in accordance with preset audio processing processes. The processor 250 may be achieved by a system-on-chip where various functions are integrated, or an image processing board (not shown) where individual chip-sets for performing their respective processes independently of each other are mounted to a printed circuit board.

In this exemplary embodiment, if the rating is given to a content image displayed on the display 210 through the input 230, the processor 250 transmits content and rating information to the server 100 through the communicator 220. Further, the processor 250 processes a content list recommended to a user of the image processing apparatus 200 to be displayed on the display 210, thereby recommending content highly preferred by the user.

Below, elements of the server 100 will be described.

The server communicator 120 interactively communicates with one or more image processing apparatuses 200 through the wide area network. The server communicator 120 receives the content and the rating information from the image processing apparatus 200, and transmits them to the processor 250, thereby building or upgrading the foregoing user-content matrix.

The server storage 140 stores data under control and process of the server processor 150. The server storage 140 is achieved by a non-volatile memory to retain the stored data. In this exemplary embodiment, the server storage 140 stores the user-content matrix, and returns data corresponding to retrieval of the server processor 150 from the user-content matrix.

The server processor 150 builds or updates the user-content matrix stored in the server storage 140 based on information received in the server communicator 120. Further, the server processor 150 may provide a content recommendation list based on the ratings of the user-content matrix, or a content recommendation list designated as a default in the server 100 as necessary to the image processing apparatus 200.

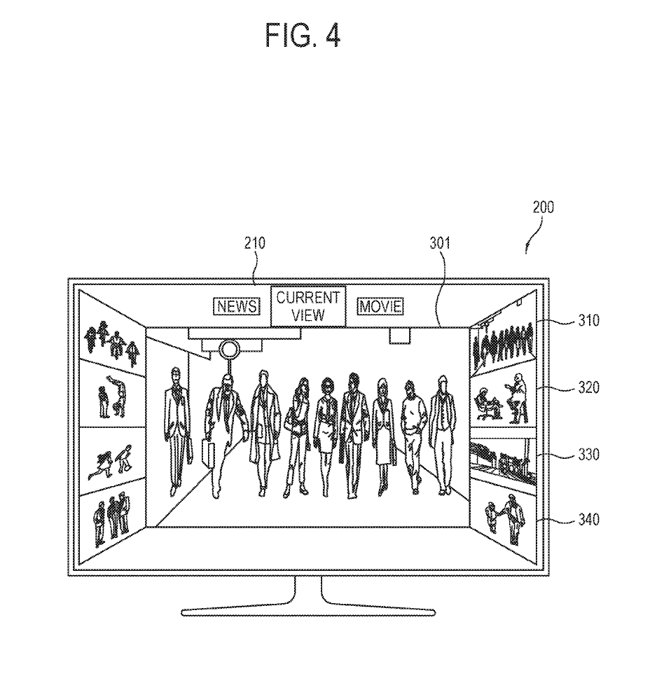

FIG. 4 shows an example of a recommendation content list displayed on the image processing apparatus 200 in the system of FIG. 1.

As shown in FIG. 4, the image processing apparatus 200 may display the recommendation content list on the display 210. The image processing apparatus 200 may process a main image 301 being currently viewed by a user to be displayed at the center of the display 210, and a list of thumbnail content images to be displayed at lateral sides of the main image 301 tridimensionally according to categories. For example, a recommendation content list of a news category is displayed at the left side of the main image 301, and a recommendation content list of a movie category is displayed at the right side of the main image 301. Here, a category may be changed as a list corresponding to each category slides in response to a user's input.

In an early stage of using the image processing apparatus 200 by a user, the server 100 provides a previously designated recommendation content list, and the image processing apparatus 200 displays the list received from the server 100. In case of the movie category, thumbnail images of a first content 310, a second content 320, a third content 330 and a fourth content 340 are arranged in order of recommendation so that a user can select one of the thumbnail images to be displayed as the main image 301.

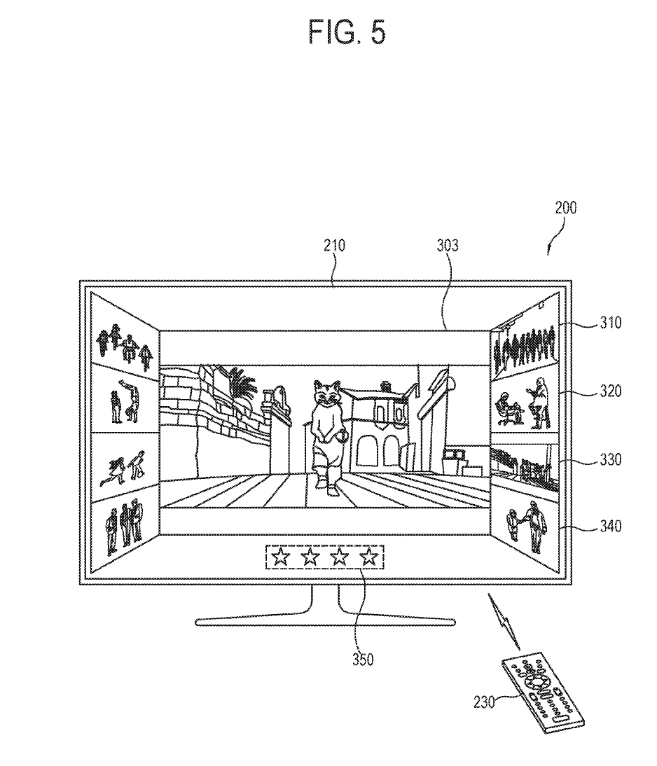

FIG. 5 shows an example that a user gives a rating to content being currently displayed on the image processing apparatus 200 in the system of FIG. 1.

As shown in FIG. 5, a user may for example select a thumbnail image of the third content 330 in the recommendation content list of the movie category so that the third content 330 can be displayed as a main image 303. When the third content 330 is displayed as the main image 303, the image processing apparatus 200 processes a user interface (UI) 350 for allowing a user to give a rating to the third content 330 to be displayed in a lower end portion of the main image 303. In this embodiment, the rating may be given as the number of star-shaped figures. Alternatively, the image processing apparatus 200 may receive the rating given by a user through the input 230 without displaying any separate UI 350.

The image processing apparatus 200 displays a previously given rating while displaying the UI 350. By controlling the input 230, a user adjusts the rating in the UI 350.

In this exemplary embodiment, the server 100 collects ratings of content, which are input from the respective image processing apparatuses 200, and builds a large-scale user-item rating dataset, i.e. the user-content rating matrix (see FIG. 2). The server 100 previously calculates the ratings with regard to all pieces of content of which ratings can be calculated according to users, and caches the ratings in the image processing apparatus 200 of each user. That is, the server 100 predicts a rating based on a preset algorithm with regard to content to which a certain user gives no rating in the user-content rating matrix, and transmits the content ratings predicted for the certain user to the image processing apparatus 200 so that the image processing apparatus 200 can store the predicted ratings.

The image processing apparatus 200 receives content ratings of a user from the server 100 and caches them in a user rating caching table (URCT). The URCT may be provided in the storage 240 (see FIG. 3), or a random access memory (RAM, not shown) to be used by the processor 250 (see FIG. 3), or a separate register (not shown).

To provide a content recommendation service based on a user's preference, the image processing apparatus 200 selects content recommended based on the rating information cached in the URCT, and provides a list of recommended content to a user. Thus, it is possible to reduce time taken in calculating the ratings needed for practical recommendation as compared with that of when the server 100 directly selects content recommended for a user from the user-content rating matrix.

Further, the image processing apparatus 200 updates the rating cached in the URCT with a rating newly given by a user with regard to a certain piece of content, and transmits caching data of the URCT to the server 100 at preset time intervals. Thus, it is possible to prevent an excessive burden even though many image processing apparatuses 200 have temporary access to the server 100, and guarantee real-time reflection of the collaborative recommendation service.

The collaborative recommendation is based on information about a user who has the most similar preference to a user, i.e. an active user who will get the recommendation service. If a request for the recommendation service is made, an algorithm is executed for calculating similarity between an active user and other users to determine a user who has the most similar propensity to the active user. Then, null data of the active data is replaced by a specific rating based on an item rating of a user who is determined as having the most similar propensity to the active user, and thus items having a preset rating or higher are recommended based on the ratings given in this manner.

Below, it will be described that a rating of a previously stored user-item matrix is updated when the server 100 receives information about a rating given to a predetermined item by a user of a certain image processing apparatus 200. In this exemplary embodiment, each item corresponds to each piece of the content.

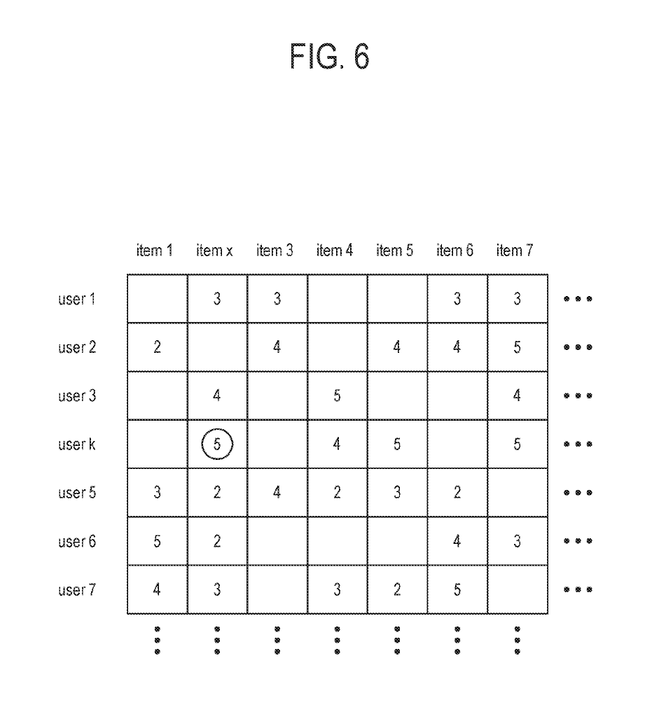

FIG. 6 shows an example that a certain user updates a rating of a certain item in a dataset of a user-item matrix, according to an exemplary embodiment.

As shown in FIG. 6, a dataset of users “user 1” to “user 7” and items “item 1” to “item 7” will be described for example. In this dataset, users' ratings are given to the respective items. The server 100 builds and updates the dataset based on the rating information collected from the respective image processing apparatuses 200.

Under this condition, suppose that the server 100 receives information that a rating of an item “item x” is updated with 5 points by a user “user k.” In this case, a rating may be newly given in the state that the rating of the “user x” corresponding to the “user k” is null data, or the rating of not 5 points may be updated with 5 points.

As the “user k” makes an activity of updating the rating of the “item x” with 5 points, the server 100 discriminates between items affected and unaffected by similarity according to the activities in the dataset of FIG. 6.

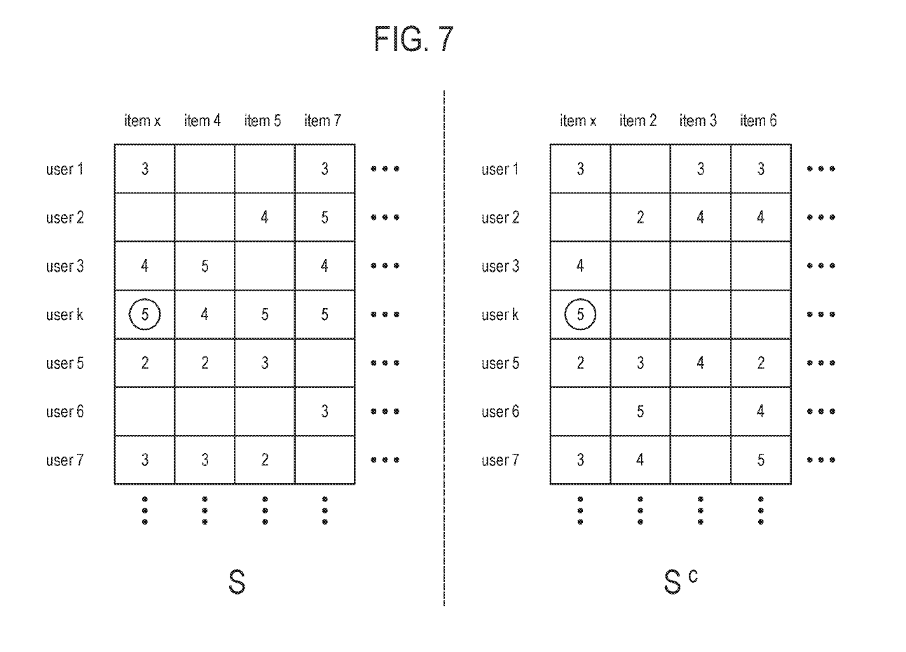

FIG. 7 shows an example of discriminating between items affected and unaffected by similarity according to a user's activities in the dataset of FIG. 6.

As shown in FIG. 7, the server 100 classifies data of the dataset into a set S of items affected by similarity according to activities of the “user k” and a set SC of items unaffected by the similarity according to the activities of the “user k.”

The set S refers to a set of items to which the “user k” gives ratings. In this example, the set S includes the “item 4,” the “item 5” and the “item 7.” A complementary set SC of the set S refers to a set of items to which the “user k” does not give any rating. In this example, the set SC includes the “item 1,” the “item 3” and the “item 6.”

The server 100 recalculates similarity with regard to only the set S classified as above, and makes a cache of the rating recalculated based on the recalculated similarity to thereby update the URCT of the image processing apparatus 200 of the “user k” with the recalculated rating.

Below, a method of calculating similarity with regard to a lot of items will be described. This calculation will be called an incremental similarity computation (ISC).

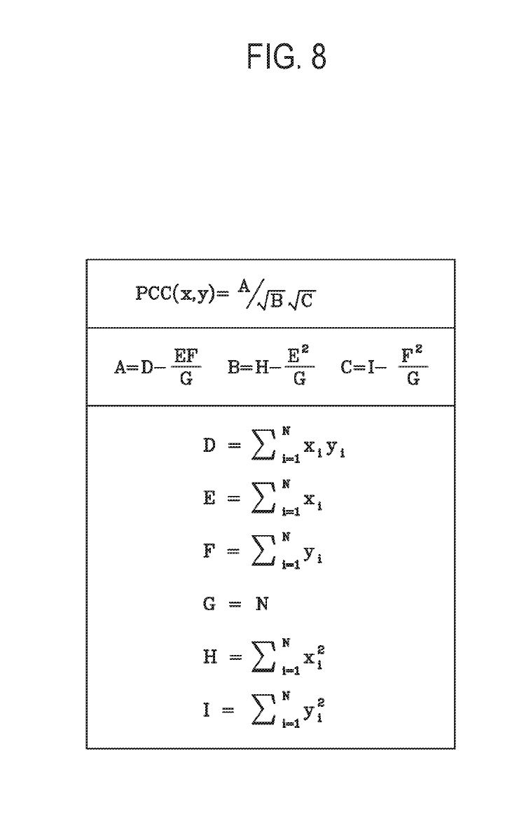

FIG. 8 shows an example of a set of equations for incremental similarity computation according to an exemplary embodiment.

As shown in FIG. 8, if an active user, i.e. a first user gives a rating of x to an item and a second user different from the first user gives a rating of y to an item, PCC(x,y) refers to similarity between these two users with regard to the item. PCC is the abbreviation for Pearson Cross Correlation. If the first user gives a new rating or updates the existing rating with a new value, a correlation between the first user and the other users is recalculated.

PCC(x,y) involves middle factors of A, B and C, and these A, B and C also involve sub factors of D, E, F, G, H and I. Equations of D, E, F, G, H and I are as shown in FIG. 8, in which N is a total number of items and i is an identification number of each item, i.e. indicates the “i”th item.

Three cases may be derived from such an equation: there may be a case where a new rating is given to an item of null data having no rating, a case where an item having a rating is changed into an item of null data by deleting the rating, and a case where an item having a rating is updated with a different rating.

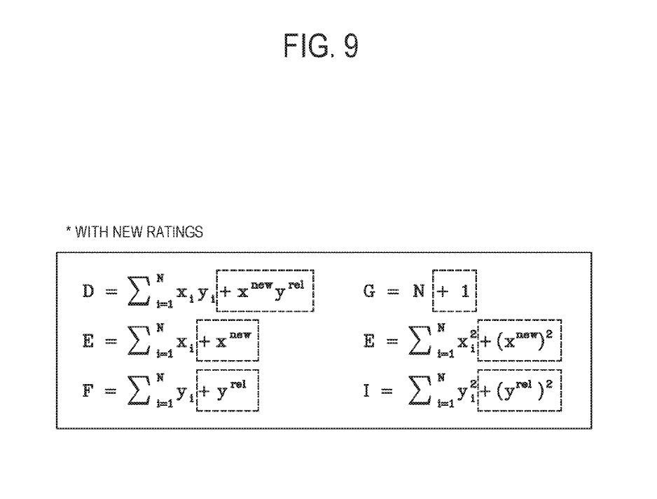

FIG. 9 shows an example of equations of respective factors when a new rating is given to an item having no rating in the set of equations of FIG. 8.

If the first user gives a new rating to the item, D to I are as shown in FIG. 9, in which “N” is a total number of items, “i” is an identification number of the item, “x^{new}” is a rating newly given by the first user to the item, and “y^{rel}” is a rating given by the second user to the item.

In comparison with the foregoing equations of D to I in FIG. 8, the equations of FIG. 9 additionally include terms surrounded with dotted lines. Such an additional term is called an increment and is regarded as a factor needed to be calculated after giving a new rating.

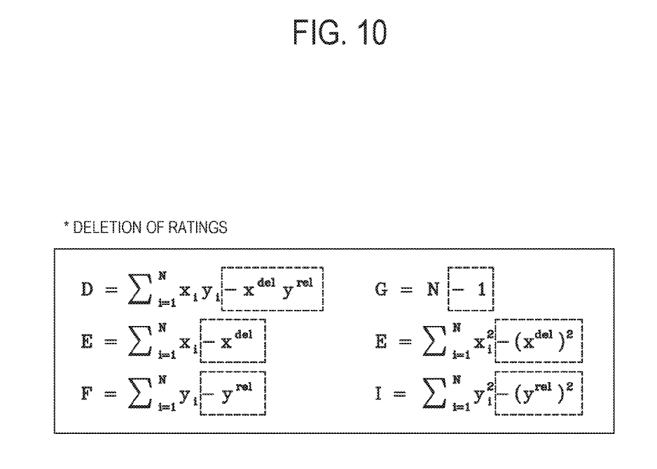

FIG. 10 shows an example of equations of respective factors when a rating is deleted from an item having the rating in the set of equations of FIG. 8.

If the first user deletes a rating from an item having the rating, D to I are as shown in FIG. 10, in which “x^{del}” is the rating of the item to be deleted by the first user, and “y^{rel}” is the rating given by the second user to the item.

The foregoing increment of FIG. 9 is approximately similar to an increment of this exemplary embodiment. However, the former has a plus sign (+), but the latter has a minus sign (−).

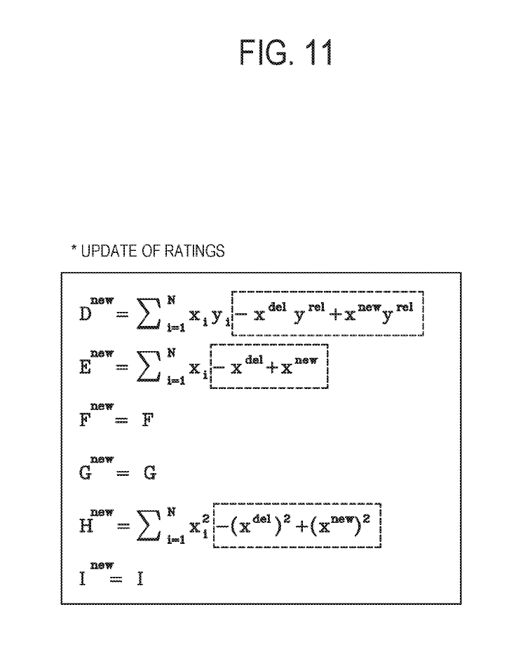

FIG. 11 shows an example of equations of respective factors when the existing rating is updated with a difference value in the set of equations of FIG. 8.

If the first user gives another rating to an item having a certain rating, “D^{new},” “E^{new},” “F^{new},” “G^{new},” “H^{new}” and “I^{new}” for replacing D to I are as shown in FIG. 11, in which F, G and I are equal to those of FIG. 8.

The case of updating the rating is the same as the case of adding a new rating after deleting the existing rating. Therefore, the increment in this example is given in the form of the sum of the increment in the equation of FIG. 9 and the increment in the equation of FIG. 10.

By the incremental similarity computation based on the foregoing equations, it is possible to make the rating be newly given to, deleted from and updated in a large-scale user-item matrix according to a user's activities. As compared with the conventional method, the method according to the present exemplary embodiment reduces the number of computations, copes with both addition and deletion of the rating, and avoids repetitive computations, thereby resulting in decreasing the burden of the system during the computations.

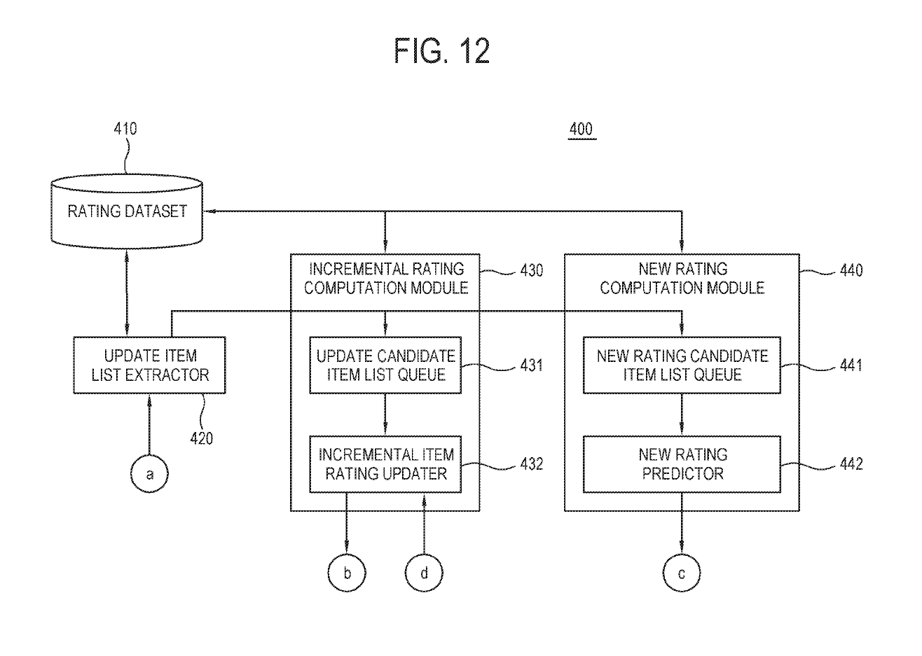

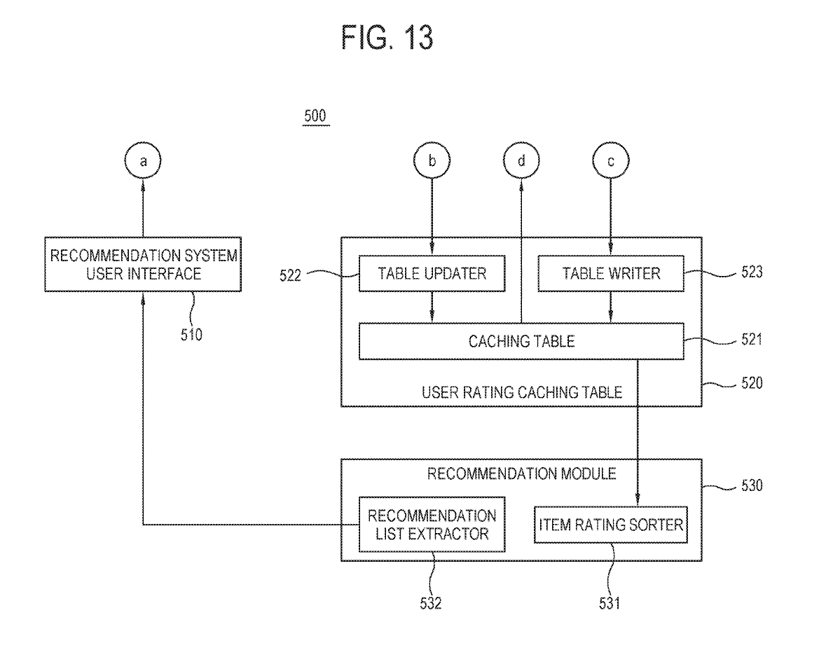

FIG. 12 is a block diagram of a server 400 for providing a recommendation service based on a user-item environment according to an exemplary embodiment, and FIG. 13 is a block diagram of an image processing apparatus 500 for providing a recommendation service based on a user-item environment according to an exemplary embodiment.

As shown in FIG. 12 and FIG. 13, the server 400 includes a rating dataset 410, an update item list extractor 420, an incremental rating computation module 430, and a new rating computation module 440.

On the other hand, the image processing apparatus 500 includes a recommendation system user interface 510, a user rating caching table 520, and a recommendation module 530.

The foregoing elements may be achieved in each processor (not shown) of the server 400 and the image processing apparatus 500. In this exemplary embodiment, the elements are divided according to functions, but not limited thereto. Alternatively, the elements may be actually not divided but integrated into a single processor (not shown) in terms of hardware.

Below, the elements of the server 400 will be described.

The rating dataset 410 includes a user-item rating matrix. That is, the rating dataset 410 includes ratings for a plurality of items according to a plurality of users, and may be for example achieved as shown in FIG. 2. The rating dataset 410 may be stored in the storage (not shown) of the server 400.

The update item list extractor 420 extracts items affected by similarity in response to activities (CD) with reference to the ratings previously given by a user from the rating dataset 410 if the user makes activities through the image processing apparatus 500. Further, the update item list extractor 420 classifies the extracted items into items of which ratings have to be computed again and items in which new ratings have to be computed, and transmits the former items to the incremental rating computation module 430 and the latter items to the new rating computation module 440. The items of which ratings need to be computed refer to items having the previously given ratings to be recalculated with difference values, and the items in which new ratings have to be computed refer to items having null date as the existing rating to be given with a new value.

The incremental rating computation module 430 includes an update candidate item list queue 431, and an incremental item rating updater 432.

The update candidate item list queue 431 is temporarily loaded with items transmitted from the update item list extractor 420. The update candidate item list queue 431 includes a queue of items to be processed by the incremental item rating updater 432, and deletes an item if the item is completely processed by the incremental item rating updater 432.

The incremental item rating updater 432 applies incremental recalculation to items, of which the rating loaded in the update candidate item list queue 431 have to be recalculated, with reference to data of a user rating caching table 520 (\textcircled{d}). The incremental item rating updater 432 updates the user rating caching table 520 with such a recalculated result (\textcircled{b}).

The new rating computation module 440 includes a new rating candidate item list queue 441, and a new rating predictor 442.

The new rating candidate item list queue 441 is temporarily loaded with items received from the update item list extractor 420. The new rating candidate item list queue 441 includes a queue of items to be processed by the new rating predictor 442, and deletes an item if the item is completely processed by the new rating predictor 442.

If it is possible to calculate a rating of an item which is not cached in the user rating caching table 520 since its rating is unpredictable due to inadequate relevant information in the rating dataset 410, the new rating predictor 442 calculates the rating of the item and makes a cache in the user rating caching table 520 (\textcircled{c}).

Below, elements of the image processing apparatus 500 will be described.

The recommendation system user interface 510 inclusively refers to a general interface for a user's input/output in the image processing apparatus 500. The recommendation system user interface 510 includes a remote controller or the like user input (not shown) as an input interface, and a display (not shown) for displaying an image or a loudspeaker (not shown) for outputting a sound as an output interface.

The user rating caching table 520 includes a caching table 521, a table updater 522, and a table writer 523.

The caching table 521 makes a cache to store ratings predicted with regard to items to which a user of the image processing apparatus 500 does not give ratings, and factors employed in calculating the ratings. Such ratings are provided from the server 400, and the stored ratings and factors are updated or modified under control and instruction of the server 400. The caching table 521 is achieved in a volatile or nonvolatile memory (not shown) of the image processing apparatus.

The caching table 521 transmits rating information corresponding to each piece of content stored in the caching table 521 to the recommendation module 530 if a recommendation service event occurs. At this time, the caching table 521 may select and transmit pieces of content having a rating higher than a preset value and rating information about the corresponding pieces of content to the recommendation module 530 in accordance with a previously designated rule.

The caching table 521 provides the cached information to the incremental item rating updater 432, so that the incremental item rating updater 432 can recalculate the rating with regard to the item. The caching table 521 may provide the cached information to the incremental item rating updater 432 not in real time but periodically at preset time intervals. Since the operations of providing the cached information are performed not in real time but at preset time intervals, it is possible to decrease the burden and traffic caused when many image processing apparatuses 500 simultaneously access the server 400.

Further, the image processing apparatus 500 may encrypt the cached information and then transmit it to the server 400 in consideration of security while providing the cached information. The incremental item rating updater 432 decrypts the cached information received from the image processing apparatus 500 and then performs recalculation.

The table updater 522 receives the rating information updated by the incremental item rating updater 432 and reflects it in the caching table 521. The table updater 522 updates the rating of the item cached in the caching table 521 with a new rating received from the incremental item rating updater 432.

The table writer 523 newly adds the rating information received from the new rating predictor 442 to the caching table. Since the rating of the item, of which the rating will be received from the new rating predictor 442, is not cached in the caching table 521, the table writer 523 adds the rating of the item to the caching table 521.

The recommendation module 530 includes an item rating sorter 531, and a recommendation list extractor 532.

The item rating sorter 531 sorts pieces of content in order of rating if a plurality of pieces of content is acquired from the caching table 521.

The recommendation list extractor 532 arranges the pieces of content in order sorted by the item rating sorter 531, and generates a recommendation content list. The recommendation list extractor 532 transmits the generated recommendation content list to the recommendation system user interface 510, thereby provides the recommendation content list it to a user.

Like this, the user rating caching table 520 storing users' ratings predicted according to the items is cached in the image processing apparatus 500 of each user, so that content determined to be highly preferred by a user can be recommended quickly.

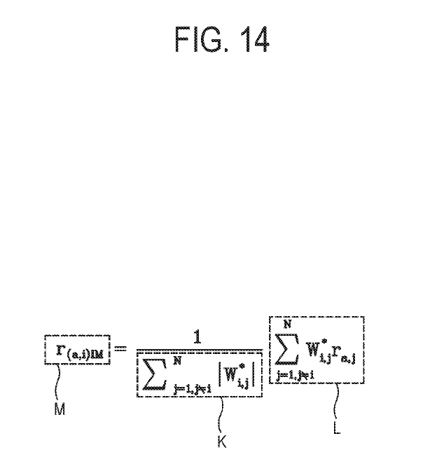

FIG. 14 shows an example of an equation that represents a correlation between factors to be cached in a user rating caching table (URCT) of the image processing apparatus according to an exemplary embodiment;

As shown in FIG. 14, ratings are predicted with regard to all items previously predictable according to users, and the predicted ratings are cached in the URCT of the image processing apparatus of each user. Thus, a recommendation service for items is provided based on the ratings cached in the URCT.

In the URCT, factors of K, L and M are cached according to items. In the equation of FIG. 14, “a” indicates a “user a” as an identification symbol of a user, “i” and “j” indicate a “item i” and an “item j” as identification symbols of items, “w_{i, j}*” indicates similarity between the item i and the item j, and “r_{a, j}” indicates a rating given by the user a to the item j.

“r_{(a, j)IM}”, i.e. M indicates a rating predicted to be given by the user a to the item i, i.e. the ith item. That is, even if the user a does not give any rating to the item i, the rating of the item i is predicted by the equation of FIG. 14 and then cached in the URCT. To provide the recommendation service, the image processing apparatus selects the items, of which M is higher than a preset ranking, as a recommendation item based on M term of each item in the URCT.

“w_{i, j}*” is calculated by expression of “{n*IS_{i, j}+(τ−n)*MS_{i, j}}/τ”. In this expression, “IS_{i, j}” indicates similarity between items i and j calculated by the user-based collaborative recommendation, and “MS_{i, j}” indicates similarity between items i and j calculated by the item metadata-based collaborative recommendation based on term frequency (TF)- inverse document frequency (IDF) information. Further, “n” indicates reliability of “IS_{i, j}” as the number of users who give ratings to both the items i and j in common with one another when the similarity is calculated by the user-based collaborative recommendation, and “τ” is a constant that shows a threshold of reliability.

Here, TF-IDF is as follows. A term frequency (TF) refers to a value that shows how many times a certain term appears in a document. The higher the value of the TF, the more important the term in the document. However, if the term is frequently used in the document, it means that the term is common. This is called a document frequency (DF) that refers to the number of documents where the certain term appears. An inverse of the DF is called an inverse document frequency. In brief, TF-IDF refers to a statistical value that shows how important a certain term is in a certain document if there is a document group including many documents, and this is expressed in a product of TF and IDF.

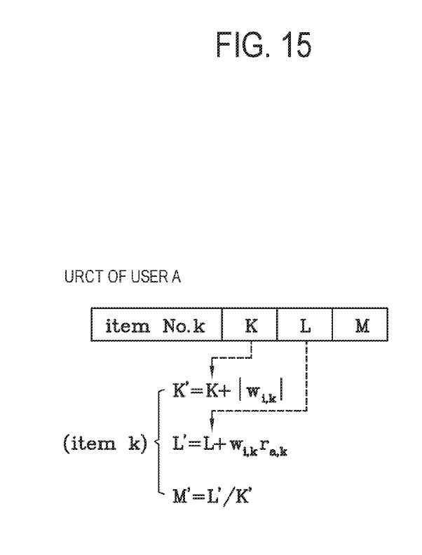

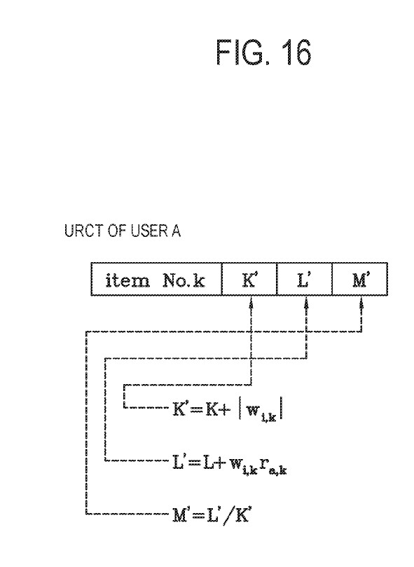

FIG. 15 and FIG. 16 are examples of recalculating the rating by incremental computation with reference to the URCT and caching the recalculated and updated ratings in the URCT according to an exemplary embodiment.

Referring to FIG. 15, suppose that new activities occur to update a rating of kth item by way of example in the state that the values of K, L and M are cached in the URCT with regard to each item. The values k and L previously cached in the URCT are replaced by K′ and L′ as they are respectively added with increments. Here, “w_{i, k}” indicates similarity between the ith item and the kth item, and the “r_{a, k}” indicates a rating given by the user a to the kth item. Further, M′ is derived from K′ and L′.

As shown in FIG. 16, K′, L′ and M′ calculated with regard to the kth item respectively replace K, L and M of the kth item in the URCT of the user a. Since the URCT of the image processing apparatus is updated by reflecting content of activities for updating the rating, it is possible to select an item recommended by a real-time collaborative recommendation while providing the item recommendation service in the future.

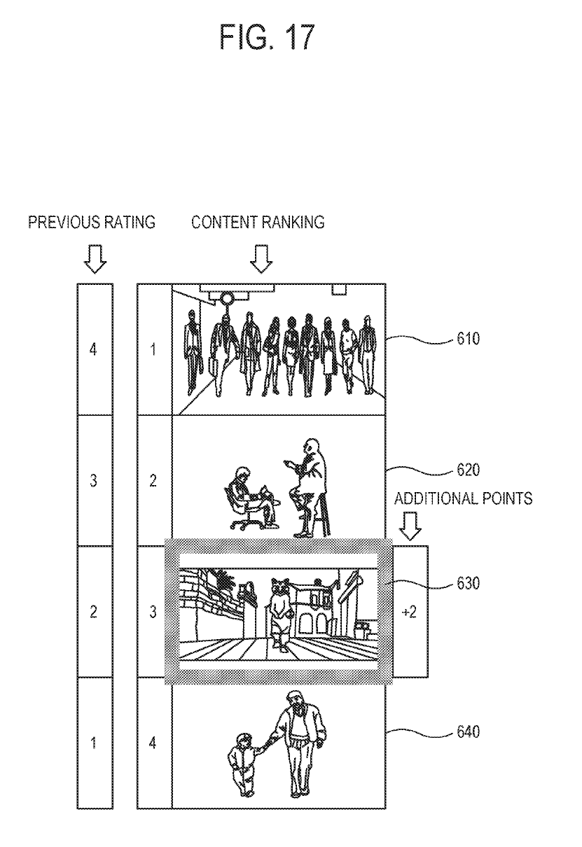

FIG. 17 shows an example of the recommendation content list displayed in the image processing apparatus according to an exemplary embodiment.

As shown in FIG. 17, the image processing apparatus may automatically display a recommendation content list in response to a user's request for recommended content or in accordance with a preset rule. The recommendation content list includes thumbnail images of four highest rating pieces of content 610, 620, 630 and 640 based on the rating information cached in the URCT, and the thumbnail images of the content 610, 620, 630 and 640 are arranged in order of rating. The recommendation content list involves a ranking of content, the thumbnail images of the content 610, 620, 630 and 640, and the ratings of the content 610, 620, 630 and 640.

In this example of the recommendation content list, first content 610 takes the first ranking with a rating of 4 points, second content 620 takes the second ranking with a rating of 3 points, third content 630 takes the third ranking with 2 points, and fourth content 640 takes the fourth ranking with 1 point. These ratings and rankings are based on the information currently cached in the URCT of the image processing apparatus.

Under this condition, a user of the image processing apparatus or another user of another image processing apparatus may make activities of giving a rating of +2 to the third content 630. As described above with reference to FIG. 14 to FIG. 16, K, L and M of the third content 630, which are cached in the URCT, are respectively updated with K′, L′ and M′ according to the activities.

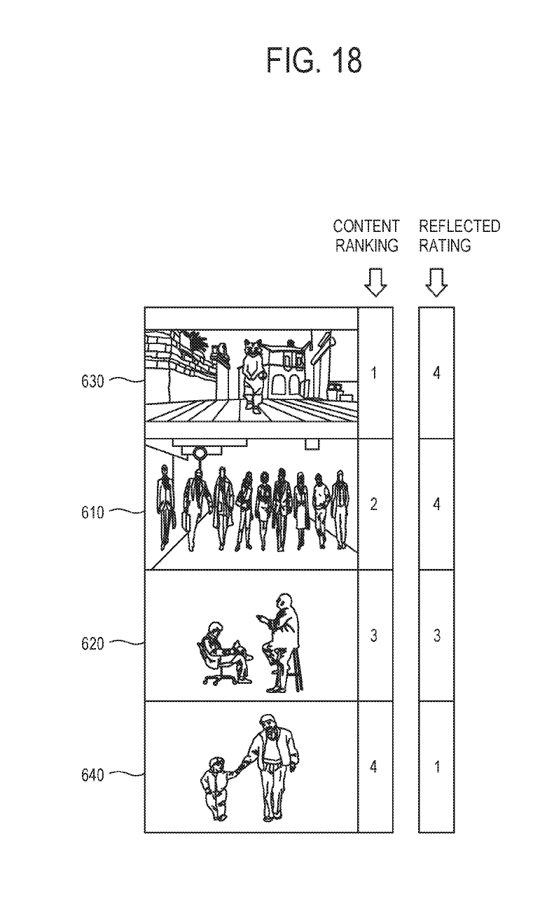

FIG. 18 shows an example of the recommendation content list displayed after updating the ratings from the recommendation content list of FIG. 17;

As shown in FIG. 18, the image processing apparatus processes the recommendation content list to be displayed after updating the rating. Since the recommendation content list is based on the information currently cached in the URCT, it is generated reflecting the content of which the previous rating has been updated. According to activities of updating the rating of the third content 630, the rating of the third content 630, which is cached in the URCT, is changed. Thus, the image processing apparatus adjusts the ranking of the content in the recommendation content list in accordance with the updated rating of the third content 630, and processes the updated rating to be displayed.

According to this method, it is possible to provide a user with the recommendation content list in which the user's intention is relatively quickly reflected. For example, suppose that a third party may give a rating to each piece of content differently from a user's intention through a user's image processing apparatus. The rankings and ratings of the pieces of content to be displayed in the recommendation content list may be varied depending on the ratings given by the third party. However, if a user adjusts the rating of this content again, the ranking and rating of the pieces of content to be displayed in the recommendation content list are easily restored by reflecting the user's intention.

That is, according to this exemplary embodiment, previously predicted and calculated users' ratings of items are respectively cached in the URCTs of the image processing apparatuses of the users, and it is thus possible to minimize time taken in calculating the ratings needed for providing an actual recommendation service.

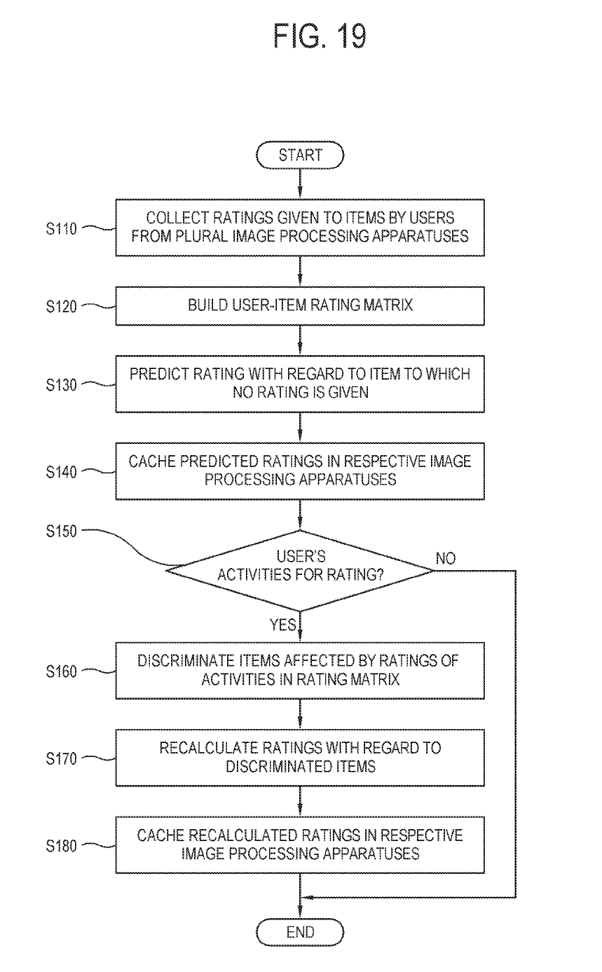

Below, a method of controlling a server according to an exemplary embodiment will be described with reference to FIG. 19. According to the present exemplary embodiment, the server communicates with a plurality of image processing apparatuses, and the image processing apparatus operates as a client corresponding to a user.

FIG. 19 is a flowchart of controlling the server according to an exemplary embodiment.

As shown in FIG. 19, at operation S110 the server collects ratings given to items by users of a plurality of image processing apparatuses from the plurality of image processing apparatuses.

At operation S120 the server builds a user-item rating matrix with the collected ratings.

At operation S130 the server predicts a rating based on similarity between users with regard to an item to which no rating is given in the built rating matrix. That is, if the rating matrix has null data, the server predicts and gives a rating to the null data by referring to ratings of other users who have the most similar preference to the user.

There may be many methods of referring to the ratings. As one example of the methods, the server may specify a second user who has a similar preference to a first user corresponding to null data of an item, and give a rating, which has been given by the second user to the same item, to the null data.

As another example of the methods, the server may determine a distribution of ratings given by a first user according to items, and predict a rating within the range of the distribution. In the case where the server predicts a rating with regard to an item corresponding to null data, if the first user gives a rating not higher than 3 points to the other items of a category to which the item corresponding to null data belongs, the server may predict the rating not to be higher than 3 points with regard to the item corresponding to the null data even though the second user gives a rating not lower than 4 points to the same item.

At operation S140 the server transmits the ratings of the items, which includes the predicted ratings, to be cached in the respective image processing apparatuses of the users. With this, the image processing apparatus makes a cache of user's ratings with regard to items. Thus, the cached ratings include not only the ratings given by a user to the items but also the ratings predicted by the server with regard to the items to which the user does not give any rating.

However, the server does not surely predict ratings with regard to all items, and may not predict a rating of a certain item if relevant information needed for prediction is insufficient. This item is tabulated with null data, and then a rating of this item may be given or predicted according to activities of a user.

If a user makes activities for a rating at operation S150, at operation S160 the server discriminates items affected by the ratings of the activities in the rating matrix. Here, the activities refer to a user's input operations of updating a rating, inputting a new rating, deleting a rating, etc.

At operation S170 the server recalculates the ratings with regard to the discriminated items. The method of recalculating the ratings is as described in the foregoing exemplary embodiments.

At operation S180 the server makes the recalculated ratings be transmitted to and cached in each of the image processing apparatuses.

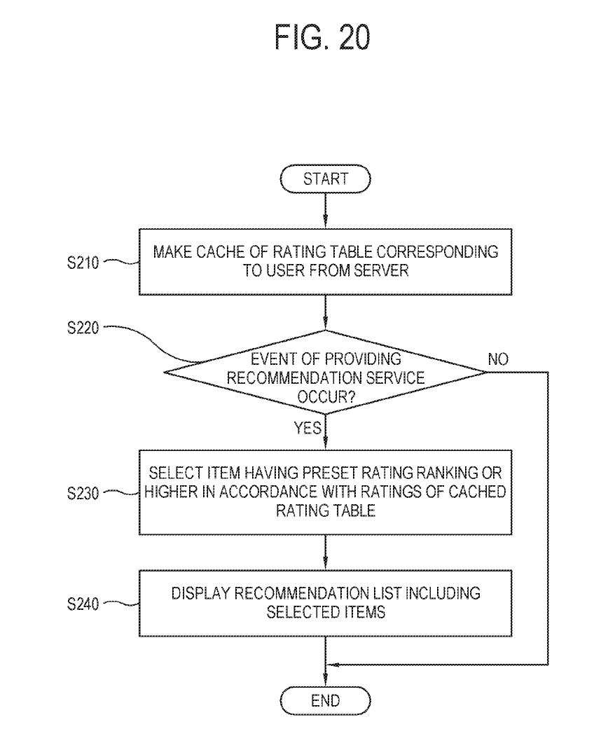

Below, a method of controlling the image processing apparatus according to an exemplary embodiment will be described with reference to FIG. 20.

FIG. 20 is a flowchart of controlling the image processing apparatus according to an exemplary embodiment.

As shown in FIG. 20, at operation S210 the image processing apparatus caches a rating table corresponding to a user and received from the server. The rating table is transmitted from the server in the foregoing operation S140 of FIG. 19, and includes one of the rating given by a user of the image processing apparatus with regard to each item and the rating not given by the user but predicted by the server. Further, the rating table includes only the ratings corresponding to the user of the image processing apparatus.

If the image processing apparatus at operation S220 determines that an event of providing a recommendation service occurs, at operation S230 the image processing apparatus selects an item having a preset rating ranking or higher in accordance with the ratings of the cached rating table.

At operation S240 the image processing apparatus displays a recommendation list including the selected items.

Below, effects of the present exemplary embodiment will be described with reference to a simulation test. In the following drawings, importance is set on comparison in difference between a method of the present exemplary embodiment and a conventional method, and it is therefore omitted to describe specific environments, setting values, etc. of the simulation test.

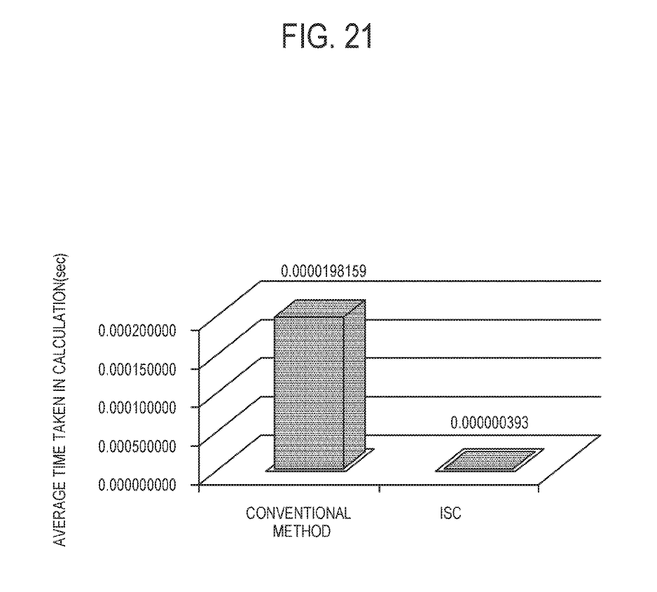

FIG. 21 is a graph showing comparison in average time taken in calculating similarity per item pair between the method according to the exemplary embodiment and the conventional method.

As shown in FIG. 21, the average time taken in calculating similarity per item pair in the system will be considered. While the conventional method takes an average time of 0.000198159 seconds, the incremental similarity computation (ISC) takes an average time of 0.000000393 seconds. Thus, the time taken in calculating the similarity by the ISC is relatively very short. This is because the ISC avoids repetitive computations and thus relatively reduces computational procedures.

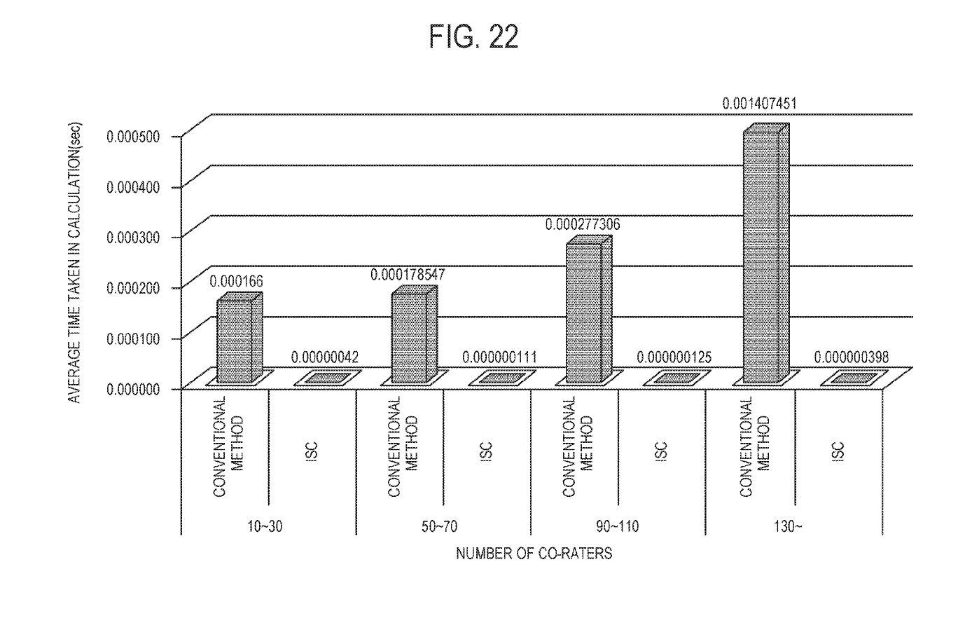

FIG. 22 is a graph showing comparison in average time taken in calculating item similarity according to the number of co-raters between the method according to an exemplary embodiment and the conventional method.

As shown in FIG. 22, the average time taken in calculating item similarity according to the number of co-raters, i.e. users who give ratings to two items in common will be considered. In case of 10 to 30 co-raters, the conventional method takes an average time of 0.000166 seconds, and the ISC takes an average time of 0.00000042 seconds. As expected, the ISC is faster than the conventional method.

By the way, the difference in average time between the ISC and the conventional method becomes definite as the number of co-raters increases. As the number of co-raters increases in ranges of 50 to 70, 90 to 110, and 130 or higher, the conventional method takes noticeably increasing average times of 0.000178549 seconds, 0.000277306 seconds and 0.001407451 seconds. On the other hand, the ISC also takes increasing average times of 0.00000111 seconds, 0.00000125 seconds and 0.00000398 seconds, but has a increasing slope gentler than that of the conventional method. That is, the ISC is more useful as the number of co-raters increases.

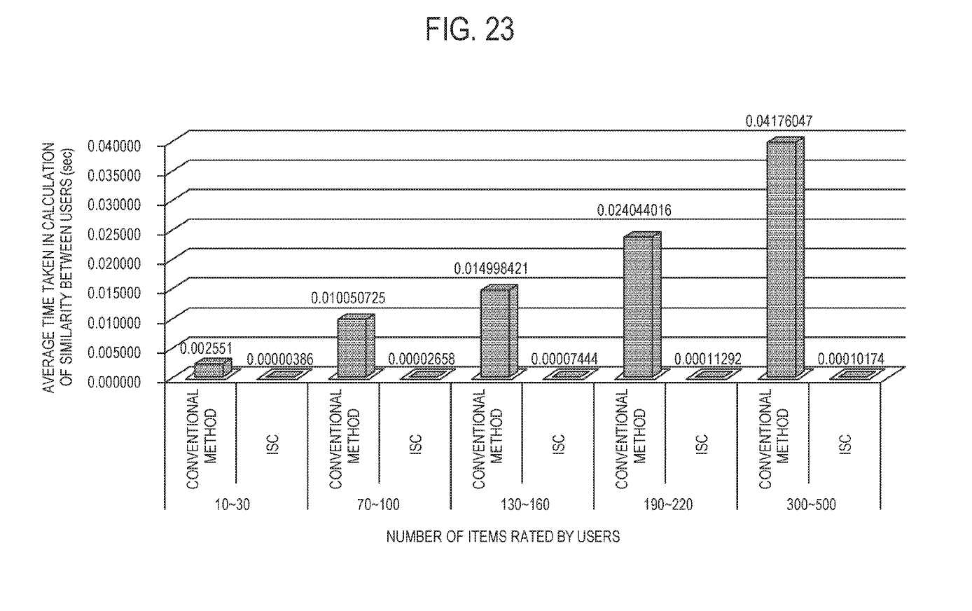

FIG. 23 is a graph showing comparison in average time taken in calculating user-item similarity according to the number of rated items between the method according to an exemplary embodiment and the conventional method.

As shown in FIG. 23, the average time taken in calculating user similarity according to the number of rated items will be considered. In case of 10 to 40 rated items, the conventional method takes an average time of 0.002551 seconds, but the ISC takes an average time of 0.00000386 seconds. By the way, if the number of rated items increases in a range of 300 to 500, the conventional method takes an average time of 0.04176047 seconds but the ISC takes an average time of 0.00010174 seconds. This means that the ISC is more useful as the number of rated items increases.

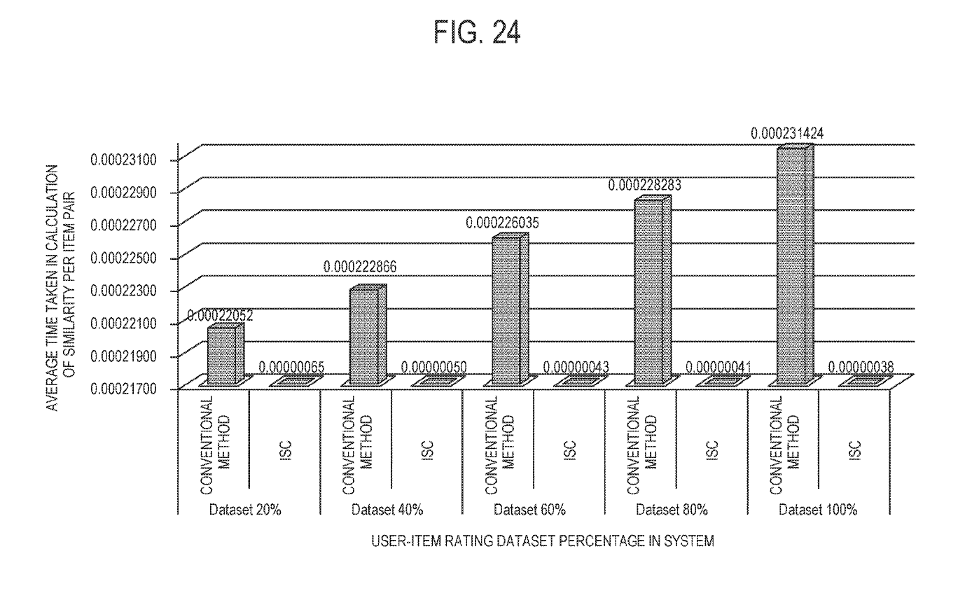

FIG. 24 is a graph showing comparison in average calculation time per item pair according to an accumulation percentage of a user-item rating dataset between the method according to an exemplary embodiment and the conventional method.

As shown in FIG. 24, average calculation time per item pair according to an accumulation percentage of a user-item rating dataset between the method according to an exemplary embodiment and the conventional method will be described. In case of a dataset accumulation percentage of 20%, the conventional method takes an average calculation time of 0.00022052 seconds but the ISC takes an average calculation time of 0.00000065 seconds. By the way, in case of a dataset accumulation percentage of 100%, the conventional method takes an average calculation time of 0.000231424 seconds but the ISC takes an average calculation time of 0.00000038 seconds, thereby showing definite difference in average calculation time between the ISC and the conventional method. In other words, as the dataset accumulation percentage increases, there is large increase in the average calculation time of the conventional method, but there is little change in the average calculation time of the ISC.

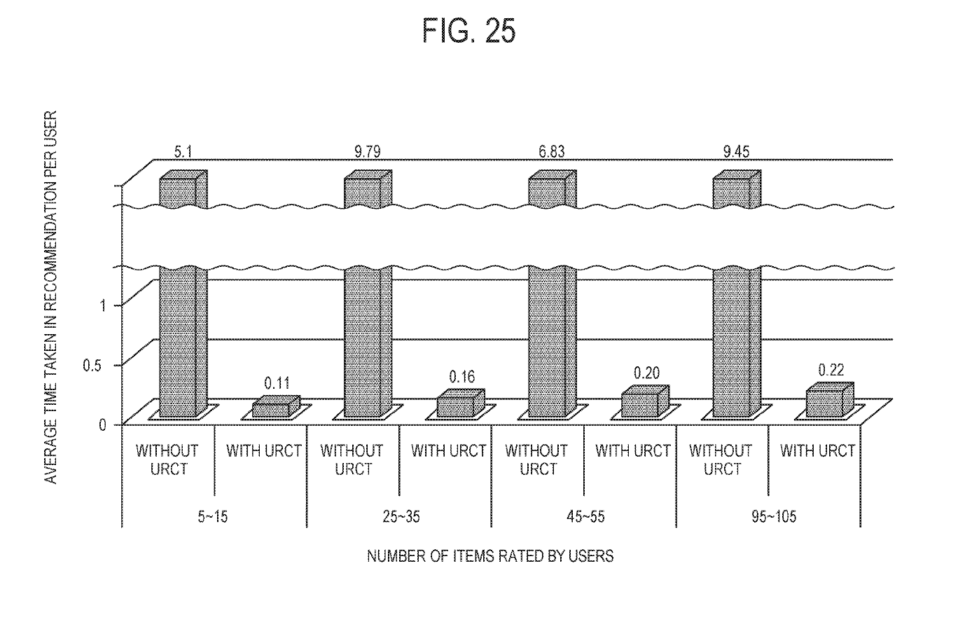

FIG. 25 is a graph showing comparison in average time taken in recommendation per user with or without the URCT between the method according to an exemplary embodiment and the conventional method.

As shown in FIG. 25, average time taken in providing a recommendation service per user in accordance with the number of rated items corresponding to each user will be considered. If the number of rated items corresponding to each user ranges from 5 to 15, it takes 5.1 seconds without the URCT, but takes 0.11 seconds with the URCT. Therefore, it will be understood that the time taken in providing the recommendation service is noticeably shortened. If the number of rated items corresponding to each user increases, it becomes more definite that the average taken time with the URCT is shorter than that without the URCT. This means that the URCT for the image processing apparatus of each user is very useful in providing a recommendation service to each user.

The methods according to the foregoing exemplary embodiments may be achieved in the form of a program command that can be implemented in various computers, and recorded in a computer readable medium. Such a computer readable medium may include a program command, a data file, a data structure or the like, or combination thereof. For example, the computer readable medium may be stored in a voltage or nonvolatile storage such as a read only memory (ROM) or the like, regardless of whether it is deletable or rewritable, for example, a RAM, a memory chip, a device or integrated circuit (IC) like memory, or an optically or magnetically recordable or machine (e.g., a computer)-readable storage medium, for example, a compact disk (CD), a digital versatile disk (DVD), a magnetic disk, a magnetic tape or the like. It will be appreciated that a memory, which can be included in a mobile terminal, is an example of the machine-readable storage medium suitable for storing a program having instructions for materializing the exemplary embodiments. The program command recorded in this storage medium may be specially designed and configured according to the exemplary embodiments, or may be publicly known and available to those skilled in the art of computer software.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

1. An image processing apparatus comprising:
a display;
a storage;
a communicator configured to communicate with an external apparatus; and
at least one processor configured to store rating information with respect to a plurality of content received from the external apparatus in the storage, and provide recommendation information about the content to be displayed on the display based on the rating information stored in the storage in response to a user's request,
wherein the at least one processor is configured;
if the user inputs a rating to a first content of the plurality of contents, to determine a rating of a second content of the plurality of contents based on the ratings of the first content input by the user, the second content having a relation to the first content,
to transmit information of the rating of the first content and the determined rating of the second content to the external apparatus through the communicator.

2. The image processing apparatus according to claim 1, wherein the at least one processor is configured to store the rating information including the ratings of the first content and the second content storage.

3. The image processing apparatus according to claim 2, wherein the recommendation information comprises a list of one or more content, and
the at least one processor selects the content, which belongs to a preset ranking, for the list based on the ratings of the rating information stored in storage.

4. The image processing apparatus according to claim 1, wherein the rating information received the external apparatus comprises a rating previously predicted by the external apparatus based on preference of a plurality of other users for the plurality of contents.

5. (canceled)

6. The image processing apparatus according to claim 1, wherein the at least one processor determines at least one of the first content having similarity with the second content by a preset level or higher, an determines the rating of the second content corresponding to the rating input to the determined at least one of the first content.

7. The image processing apparatus according to claim 1, wherein if the user makes an input of giving a rating to the content while the determined rating information is stored in the storage, the at least one processor updates the determined rating information stored in the storage in response to the input.

8. The image processing apparatus according to claim 7, wherein the at least one processor processes a user interface (UI) image to be displayed for allowing the user to give a rating to the content of the image being displayed on the display, and processes the determined rating information stored in the storage to be updated based on the rating given through the UI image.

9. A method of controlling an image processing apparatus, the method comprising:
receiving rating information with respect to a plurality of content from an external apparatus in a storage of the image processing apparatus;
if a user inputs a rating to a first content of the plurality of contents, determining a rating of a second content of the plurality of contents based on the rating of the first content input by the user, the second content having a relation to the first content;
transmitting information of the rating of the first content and the determined rating of the second content to the external apparatus; and
displaying recommendation information about the content based on the rating information stored in the storage in response to a user's request.

10. The method according to claim 9, wherein the determining the rating of the second content comprises: storing the rating information including the ratings of the first content and the second content in the storage.

11. The method according to claim 10, wherein the recommendation information comprises a list of one or more content, and
the displaying the recommendation information comprises: selecting the content, which belongs to a preset ranking, for the list based on the ratings of the rating information stored in the storage.

12. The method according to claim 9, wherein the rating information received from the external apparatus comprises a rating previously predicted by the external apparatus based on preference of a plurality of other users for the plurality of contents.

13. (canceled)

14. The method according to claim 9, wherein the determining the rating of the second content comprises determining at least one of the first content having similarity with the second content by a preset level or higher, and determining the rating of the second content corresponding to the rating input to the determined at least one of the first content.

15. The method according to claim 9, further comprising updating the determined rating information stored in the storage based on an input if the user makes the input of giving a rating to the content while the determined rating information is stored in the storage.

16. The method according to claim 7, further comprising:
displaying a UI image for allowing the user to give a rating to the content of the image being currently displayed; and
updating the determined rating information stored in the storage based on the rating given through the UI image.

17. A server comprising:
a communicator configured to communicate with a plurality of image processing apparatuses;
a storage; and
a processor configured to store rating information with respect to a plurality of contents in the storage based on ratings by one or more users to one of more contents, the ratings received from the plurality of image processing apparatuses, and in response to a request from one of the plurality of image processing apparatuses, to transmit the rating information stored in the storage to corresponding image processing apparatus through the communicator,
wherein the processor is configured, based on a relation between a first content where a rating is input by a user and a second content where a rating is not input by the user, to determine the rating of the second content.

18. The server according to claim 17, wherein the processor is configured to store the rating information including the ratings of the first content and the second content in the storage, and in response to the request, to transmit the rating information.

19. The server according to claim 17, wherein the rating information comprises ratings determined based on preferences of the respective users of the plurality of image processing apparatuses for the contents.

20. The server according to claim 19, wherein the processor determines other user having preference similar to the user of the corresponding image processing apparatus, and determines the rating of the second content based on a rating input by the other user.

21. The server according to claim 17, wherein if the user makes an input of giving a rating to the content while the determined rating information is stored in the storage, the processor updates the determined rating information stored in the storage in response to the input.

22. The server according to claim 17, wherein the processor determines a available range of the rating of the first content by the user of the corresponding image processing apparatus, and determines the rating of the second content within the available range.
